(19) United States
(12) Patent Application Publication
(10) Pub. No.: US 2023/0409631 A1
(43) Pub. Date: Dec. 21, 2023

(54) AUTOMATIC PROFILE IMAGE GENERATOR

(71) Applicant: AT&T Intellectual Property I, L.P., Atlanta, GA (US)

(72) Inventors: Casey Futterman, Hoboken, NJ (US); Derek Kneisel, Linwood, NJ (US); John Bezold, Morris Plains, NJ (US); Garrett Hope, Forked River, NJ (US); Roque Rios, III, Middletown, NJ (US)

(21) Appl. No.: 17/807,376

(22) Filed: Jun. 16, 2022

(51) Int. Cl. G06F 16/58; G06T 7/00; G06T 5/50

(52) U.S. Cl. CPC G06F 16/5866; G06T 5/50; G06T 7/97

(57) ABSTRACT

A method includes acquiring a plurality of images of a subject, acquiring a set of criteria for a profile image of the subject, and generating a new image of the subject, using the plurality of images of the subject and the set of criteria. Optionally, the method may further include selecting a first image of the plurality of images as the profile image of the subject, wherein the first image is an image of the plurality of images that best meets the set of criteria. Optionally, the method may further include generating a recommendation, where the recommendation indicates that one of: the first image or the new image should be used as the profile image for the subject.

The present disclosure relates generally to electronic media, and relates more particularly to devices, non-transitory computer-readable media, and methods for automatically selecting or generating profile images for online use.

### BACKGROUND

Many electronic applications, including social media and e-commerce applications, rely on the use of images to generate interest. For instance, users of social media or online dating applications may create profiles that include images of themselves that can be viewed by other users of the social media or online dating applications. E-commerce applications may include images of a product on a product description page for the product. These images may be as simple as a first still image that is presented, or as complex as a three-dimensional animated rendering (e.g., virtual representation).

### SUMMARY

The present disclosure broadly discloses methods, computer-readable media, and systems for automatically selecting or generating profile images for online use. In one example, a method performed by a processing system including at least one processor includes acquiring a plurality of images of a subject, acquiring a set of criteria for a profile image of the subject, and generating a new image of the subject, using the plurality of images of the subject and the set of criteria. Optionally, the method may further include selecting a first image of the plurality of images as the profile image of the subject, wherein the first image is an image of the plurality of images that best meets the set of criteria. Optionally, the method may further include generating a recommendation, where the recommendation indicates that one of: the first image or the new image should be used as the profile image for the subject.

In another example, a non-transitory computer-readable medium may store instructions which, when executed by a processing system including at least one processor, cause the processing system to perform operations. The operations may include acquiring a plurality of images of a subject, acquiring a set of criteria for a profile image of the subject, and generating a new image of the subject, using the plurality of images of the subject and the set of criteria. Optionally, the operations may further include selecting a first image of the plurality of images as the profile image of the subject, wherein the first image is an image of the plurality of images that best meets the set of criteria. Optionally, the operations may further include generating a recommendation, where the recommendation indicates that one of the first image or the new image should be used as the profile image for the subject.

In another example, a device may include a processing system including at least one processor and a non-transitory computer-readable medium storing instructions which, when executed by the processing system, cause the processing system to perform operations. The operations may include acquiring a plurality of images of a subject, acquiring a set of criteria for a profile image of the subject, and generating a new image of the subject, using the plurality of images of the subject and the set of criteria. Optionally, the operations may further include selecting a first image of the plurality of images as the profile image of the subject, wherein the first image is an image of the plurality of images that best meets the set of criteria. Optionally, the operations may further include generating a recommendation, where the recommendation indicates that one of the first image or the new image should be used as the profile image for the subject.

### BRIEF DESCRIPTION OF THE DRAWINGS

The teachings of the present disclosure can be readily understood by considering the following detailed description in conjunction with the accompanying drawings, in which:

FIG. 1 illustrates an example system in which examples of the present disclosure for automatically selecting or generating profile images for online use may operate;

FIG. 2 illustrates a flowchart of an example method for automatically selecting or generating profile images for online use, in accordance with the present disclosure; and

FIG. 3 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and systems for automatically selecting or generating profile images for online use. As discussed above, many electronic applications, including social media and e-commerce applications, rely on the use of images to generate interest. For instance, users of social media or online dating applications may create profiles that include images of themselves that can be viewed by other users of the social media or online dating applications. E-commerce applications may include images of a product on a product description page for the product. These images may be as simple as a first still image that is presented, or as complex as a three-dimensional animated rendering (e.g., virtual representation). In most cases, the owner of the profile (whether the profile is a personal profile of an individual, such as on social media, or a commercial profile of a product, such as on an e-commerce site) will try to select a profile image that best presents some aspect of themselves (or of the product) that the owner wishes to share with others.

Most profile images tend to be static. That is, an owner of the profile sets an image for presentation, and all other users who view the profile will see that same image. The image may be perceived differently by different viewers, who may have different expectations and/or preferences. Moreover, depending on the context of the platform through which the profile image is viewable, the same profile image may be considered appropriate for one platform, but inappropriate for another platform. For instance, a profile image showing the profile owner relaxing on the beach might be perceived well on a social media platform that is geared toward dating. However, the same profile image may not be perceived as well on a social media platform that is geared toward professional networking. Profile owners can perform their own manual testing, trying different profile images in order to see which images generate the best or the desired type of feedback (e.g., a desired rate of “likes,” of personal messages, of views, or the like). However, sub-optimal first impressions may be created with many viewers before the profile owner is able to determine the ideal profile image.

Moreover, a profile owner may have only a limited number of photos of themselves, and none of the photos may be appropriate for the target platform. For instance, the profile owner may wish to create a profile on a professional networking platform, but may not have any photos of themselves wearing business attire.

Examples of the present disclosure select, or if needed, generate, a profile image for a subject, based on a plurality of sample images of the subject. For instance, given the plurality of sample images and a selection of a target online platform on which a profile image is to be displayed, examples of the present disclosure may automatically select the sample image that is likely to receive the best engagement from other users of the target online platform. Within this context, best or good engagement is understood to mean that the sample image will likely be perceived by the other users in the manner that the subject wishes to be perceived (where perception could be correlated to a number of views, likes, purchases, etc.) In further examples, examples of the present disclosure may generate a wholly new (e.g., synthetic, not previously existing) image of the subject that presents the subject in a manner that is consistent with high-exposure profile images on the target online platform. Thus, if no existing images of the subject are deemed suitable for the target online platform, examples of the present disclosure can create a suitable image. As such, the best possible first impression of the subject can be created.

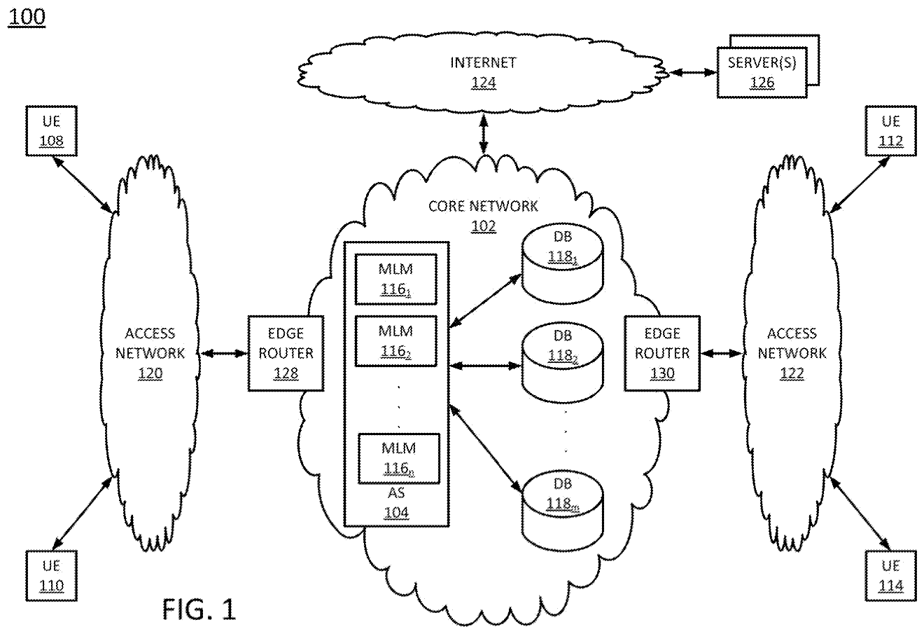

In some examples, online platforms may offer a service in which examples of the present disclosure are available to subscribers or members in order to help the subscribers or members create their profiles. Although examples of the present disclosure may be described largely within the context of human subjects and their profile images on social media, it will be appreciated that the same principles could be applied to select or generate optimal product images of non-human subjects for e-commerce. For instance, examples of the present disclosure may be used to generate or select an image of a product, where the image of the product is to be posted on a web site on which the product may be purchased or to be posted in an online advertisement (e.g., a banner advertisement, an embedded advertisement, a sponsored social media post, or the like). Examples of the present disclosure may be utilized to determine the best angle, lighting, and other effects for the image of the product, with an eye toward generating increased purchases of the product. For instance, example images of similar products that have achieved a target level of sales may be examined to determine common features of the example images, and these common features may be applied in generating, selecting, or editing an image of a product that is to be posted. These and other aspects of the present disclosure are discussed in greater detail below in connection with the examples of FIGS. 1-3.

To further aid in understanding the present disclosure, FIG. 1 illustrates an example system 100 in which examples of the present disclosure for selecting or generating profile images for online use may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wired network, a wireless network, and/or a cellular network (e.g., 2G-5G, a long term evolution (LTE) network, and the like) related to the current disclosure. It should be noted that an IP network is broadly defined as a network that uses Internet Protocol to exchange data packets. Additional example IP networks include Voice over IP (VoIP) networks, Service over IP (SoIP) networks, the World Wide Web, and the like.

In one example, the system 100 may comprise a core network 102. The core network 102 may be in communication with one or more access networks 120 and 122, and with the Internet 124. In one example, the core network 102 may functionally comprise a fixed mobile convergence (FMC) network, e.g., an IP Multimedia Subsystem (IMS) network. In addition, the core network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. In one example, the core network 102 may include at least one application server (AS) 104, a plurality of databases (DB) 118₁-118ₘ (hereinafter referred to individually as a “DB 118” or collectively as “DBs 118”), and a plurality of edge routers 128-130. For ease of illustration, various additional elements of the core network 102 are omitted from FIG. 1.

In one example, the access networks 120 and 122 may comprise Digital Subscriber Line (DSL) networks, public switched telephone network (PSTN) access networks, broadband cable access networks, Local Area Networks (LANs), wireless access networks (e.g., an IEEE 802.11/Wi-Fi network and the like), cellular access networks, 3^{rd} party networks, and the like. For example, the operator of the core network 102 may provide a cable television service, an IPTV service, or any other types of telecommunication services to subscribers via access networks 120 and 122. In one example, the access networks 120 and 122 may comprise different types of access networks, may comprise the same type of access network, or some access networks may be the same type of access network and other may be different types of access networks. In one example, the core network 102 may be operated by a telecommunication network service provider (e.g., an Internet service provider, or a service provider who provides Internet services in addition to other telecommunication services). The core network 102 and the access networks 120 and 122 may be operated by different service providers, the same service provider or a combination thereof, or the access networks 120 and/or 122 may be operated by entities having core businesses that are not related to telecommunications services, e.g., corporate, governmental, or educational institution LANs, and the like.

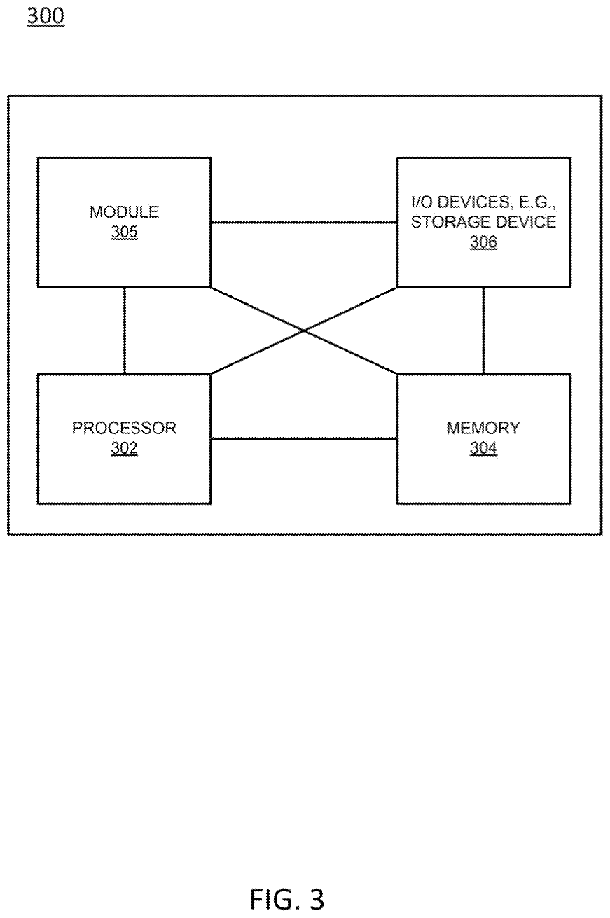

In one example, the access network 120 may be in communication with one or more user endpoint devices 108 and 110. Similarly, the access network 122 may be in communication with one or more user endpoint devices 112 and 114. The access networks 120 and 122 may transmit and receive communications between the user endpoint devices 108, 110, 112, and 114, between the user endpoint devices 108, 110, 112, and 114, the server(s) 126, the AS 104, other components of the core network 102, devices reachable via the Internet in general, and so forth. In one example, each of the user endpoint devices 108, 110, 112, and 114 may comprise any single device or combination of devices that may comprise a user endpoint device, such as computing system 300 depicted in FIG. 3, and may be configured as described below. For example, the user endpoint devices 108, 110, 112, and 114 may each comprise a mobile device, a cellular smart phone, a gaming console, a set top box, a laptop computer, a tablet computer, a desktop computer, an application server, a bank or cluster of such devices, and the like.

In one example, one or more servers 126 may be accessible to user endpoint devices 108, 110, 112, and 114 via Internet 124 in general. The server(s) 126 may be associated with Internet content providers, e.g., entities that provide content (e.g., news, blogs, videos, music, files, products, services, or the like) in the form of websites to users over the Internet 124. At least some of these Internet content providers may comprise social media providers, such as providers of social networking platforms, professional networking platforms, dating platforms, microblogging platforms, media sharing platforms, e-commerce platforms, and the like. Thus, some of the servers 126 may comprise content servers, e.g., servers that store content such as images, text, video, and the like which may be served to web browser applications executing on the user endpoint devices 108, 110, 112, and 114 in the form of websites.

In accordance with the present disclosure, the AS 104 may be configured to provide one or more operations or functions in connection with examples of the present disclosure for automatically selecting or generating profile images for online use, as described herein. The AS 104 may comprise one or more physical devices, e.g., one or more computing systems or servers, such as computing system 300 depicted in FIG. 3, and may be configured as described below. It should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

In one example, the AS 104 may be configured to receive requests from subscribers associated with the user endpoint devices 108, 110, 112, and 114, where the requests comprise requests for the selection or generation of profile images for use in online platforms. For instance, a subscriber associated with any of the user endpoint devices 108, 110, 112, and 114 may provide a plurality of images of a subject to the AS 104. The plurality of images may include still photographs, video, virtual renderings (e.g., avatars or three-dimensional models), and other types of images of the subject, where the subject may comprise a human or non-human subject (e.g., a product, a pet, a house, etc.). The subscriber may request that the AS 104 select or generate a profile image for the subject, using the plurality of images as a starting point or seed. For instance, the subscriber may specify an online platform (e.g., either a specific online platform, such as Microblogging Service A, or a more general type of online platform, such as an e-commerce site) on which the profile image is to be published. The AS 104 may then select a profile image from among the plurality images or may generate a new (not previously existing) profile image using information from the plurality of images.

The profile image that is selected or generated by the AS 104 may be selected or generated with an eye toward the most optimal image characteristics for the specified online platform. For instance, a profile image that is generated for a professional networking social media platform may depict a human subject in a business suit, while a profile image of the same human subject that is generated for a dating platform may depict the human subject in more casual attire. In one example, machine learning is leveraged to learn the characteristics of profile images that are optimal or appropriate for different online platforms or types of platforms.

In one example, the AS 104 may employ a plurality of machine learning models (MLMs) 116₁-116ₙ (hereinafter referred to individually as an “MLM 116” or collectively as “MLMs 116”). In one example, each MLM may be trained to select or generate a profile image for a different online platform or type of online platform. For instance, MLM 116₁ may be trained to select or generate profile images for professional networking social media platforms, MLM 116₂ may be trained to select or generate profile images for e-commerce platforms, and the like. Each MLM 116 may be trained on a set of relevant training images, where the relevant training images for a given MLM 116 may comprise a set of high-exposure profile images for the type of online platform for which the given MLM 116 is being trained. For instance, an MLM 116 that is trained to select or generate profile images for a professional networking social media platform may be trained on a set of profile images in which each profile image in the set has acquired at least a threshold number of views, connection requests, or the like. Profile images that have elicited such a level of engagement from other users of a particular professional networking social media platform may be considered to exhibit optimal characteristics for engagement.

In one example, the training images may be retrieved from one or more open-source datasets or databases (e.g., DBs 118), where each dataset or database contains high-exposure public profile images from different online platforms. For instance, one database 118₁ may contain public profile images with at least a threshold number of likes from a dating social media platform, while another database 118₂ may contain public profile images with at least a threshold number of views from a professional networking social media platform, and another database 118ₘ may contain public profile images with at least a threshold number of purchases from an e-commerce platform.

The MLMs 116 may utilize different types of machine learning algorithms, such as support vector machines, convolutional neural networks, decision trees, logistic regression algorithms, naïve Bayesian networks, and/or other types of classifiers, in order to learn the optimal profile image characteristics for different types of online platforms. The MLMs 116 may utilize still other types of machine learning algorithms, such as generative neural networks (GNNs), to generate new profile images. A profile image generated by a GNN may be considered a “deepfake” image in the sense that the profile image does not comprise an actual captured image of a subject, but is instead a composite of one or more images of the subject and one or more images of other subjects exhibiting “optimal” characteristics for a specified online platform. New profile images generated by the MLMs 116 may in turn be stored in one of the DBs 118 (e.g., a DB 118 corresponding to the specified online platform) and used as additional training data for training the MLMs 116 to learn and recognize optimal image characteristics.

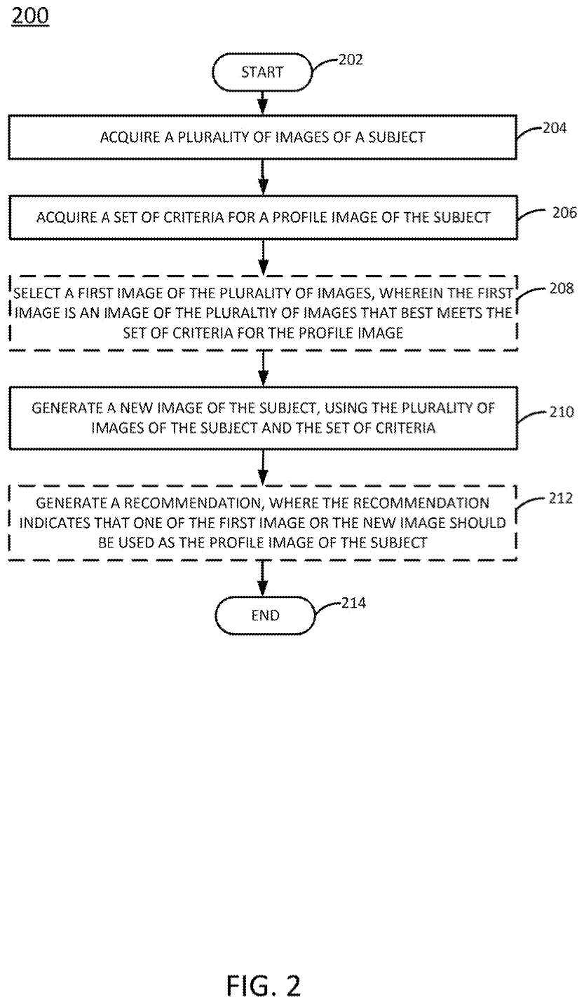

In one example, each DB 118 may comprise a physical storage device integrated with the AS 104 (e.g., a database server or a file server), or attached or coupled to the AS 104, in accordance with the present disclosure. In one example, the AS 104 may load instructions into a memory, or one or more distributed memory units, and execute the instructions for automatically selecting or generating profile images for online use, as described herein. An example method for automatically selecting or generating profile images for online use is described in greater detail below in connection with FIG. 2.

It should be noted that the system 100 has been simplified. Thus, those skilled in the art will realize that the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For example, the system 100 may include other network elements (not shown) such as border elements, routers, switches, policy servers, security devices, gateways, a content distribution network (CDN) and the like. For example, portions of the core network 102, access networks 120 and 122, and/or Internet 124 may comprise a content distribution network (CDN) having ingest servers, edge servers, and the like. Similarly, although only two access networks, 120 and 122 are shown, in other examples, access networks 120 and/or 122 may each comprise a plurality of different access networks that may interface with the core network 102 independently or in a chained manner. For example, UE devices 108, 110, 112, and 114 may communicate with the core network 102 via different access networks, user endpoint devices 110 and 112 may communicate with the core network 102 via different access networks, and so forth. Thus, these and other modifications are all contemplated within the scope of the present disclosure.

FIG. 2 illustrates a flowchart of an example method 200 for automatically selecting or generating profile images for online use, in accordance with the present disclosure. In one example, steps, functions and/or operations of the method 200 may be performed by a device as illustrated in FIG. 1, e.g., AS 104 or any one or more components thereof. In another example, the steps, functions, or operations of method 200 may be performed by a computing device or system 300, and/or a processing system 302 as described in connection with FIG. 3 below. For instance, the computing device 300 may represent at least a portion of the AS 104 in accordance with the present disclosure. For illustrative purposes, the method 200 is described in greater detail below in connection with an example performed by a processing system.

The method 200 begins in step 202 and proceeds to step 204. In step 204, the processing system may acquire a plurality of images of a subject. In one example, the plurality of images may include one or more of: still photographs, videos, virtual renderings (e.g., avatars or three-dimensional models), and/or other types of images. The plurality of images may include images of the subject from different perspectives and/or angles as well. For instance, where the subject is a human subject, the plurality of images may include close-up facial images, full-body images, side/profile images, and/or any other images that may show different views of the subject. Where the subject is a non-human subject (e.g., a commercial product), the plurality of images may include front images, back images, side images, top images, bottom images, isometric images, and/or any other images that may show different aspects of the subject. At least some of the images of the plurality of images may be edited or retouched. In one example, all images of the plurality of images may be acquired in digital form (e.g., via file upload or the like).

In step 206, the processing system may acquire a set of criteria for a profile image of the subject. As discussed above, the profile image may be a representative image of the subject that is to be displayed on a particular online platform. In one example, the set of criteria may describe a set of goals for the profile image. For instance, the set of criteria may indicate at least one of: a target platform for the profile image (e.g., the online platform in which the profile image is to be displayed), a desired reaction (of other individuals) to the profile image (e.g., a target number of views, likes, purchases, hyperlink clicks, and/or other types of interactions with the profile image). In other words, the set of criteria may define a desired perception of the profile image or a desired level of engagement of other users with the profile image.

In one example, the set of criteria may be predefined, and a user (e.g., the subject, if the subject is a human subject, or an administrator, if the subject is a non-human subject) may select the set of criteria from among a plurality of predefined options. For instance, the user may be presented with a menu of predefined options, where the predefined options may specify different online platforms for which profile images may be generated (e.g., Social Media Site A, Microblogging Site B, Dating Site C, E-Commerce site D, etc.). Alternatively, the predefined options may specify more general contexts for the profile image (e.g., professional, dating, family friendly, retail fashion, etc.). Each predefined option may be associated with a different set of criteria that embodies what an optimal profile image looks like for the corresponding predefined option or what type of engagement from other users an optimal profile image is expected to receive (e.g., views, likes, hyperlink clicks, product purchases, etc.).

In optional step 208 (illustrated in phantom), the processing system may select a first image of the plurality of images, wherein the first image is an image of the plurality of images that best meets the set of criteria. For instance, in one example, the processing system may have access to a machine learning model that has been trained to receive as input an image and a set of criteria (e.g., a selection of an online platform) and to generate as an output a score that indicates how well the image meets the set of criteria. The machine learning model may comprise, for example, a support vector machine, a convolutional neural network, a decision tree, a logistic regression algorithm, a naïve Bayesian network, and/or another type of classifier.

In one example, the processing system may have access to a plurality of machine learning models, where each machine learning model of the plurality of machine learning models has been trained to score images for match to a different set of criteria. Each machine learning model may be trained on a set of training images (e.g., high-exposure profile images) corresponding to the set of criteria. In one example, the training images may be retrieved from one or more open-source datasets or databases, where each dataset or database contains high-exposure public profile images from different online platforms. For instance, one database may contain public profile images with at least a threshold number of likes from a dating social media platform, while another database may contain public profile images with at least a threshold number of views from a professional networking social media platform, and another database may contain public profile images with at least a threshold number of purchases (or a number of days a listed house was on the market before being under contract) from an e-commerce platform.

For instance, one machine learning model may have been trained on example profile images from a professional networking platform in order to recognize features that are common to high-exposure profile images on the professional networking platform and to generate scores that indicate how well input images exhibit those features. Another machine learning model may have been trained on example profile images from an e-commerce platform that sells shoes in order to recognize features that are common to high-exposure profile images on the e-commerce platform and to generate scores that indicate how well input images exhibit those features.

Thus, in one example, each image of the plurality of images may be scored using the appropriate machine learning model for the set of criteria that is indicated. Then, the highest scoring image of the plurality of images may be selected as the first image. The first image may be the image from among the plurality of images of the subject that best exhibits the features that are desirable in profile images for the target online platform. In one example, all images of the plurality of images may be ranked (e.g., in descending order) based on the respective scores.

In step 210, the processing system may generate a new image of the subject, using the plurality of images of the subject and the set of criteria. In one example, the new image may be generated by providing the plurality of images of the subject to a machine learning model (e.g., a modified generative adversarial network, or GAN) that is trained to output a new (synthetic) image for a specific online platform based on the plurality of images of the subject.

In other words, the machine learning model may be trained to learn what the characteristics of an optimal profile image are for a given online platform and to apply those characteristics to one or more input images of a subject in order to produce a new (not previously existing) image of the subject that exhibits those characteristics. Characteristics that may influence whether an image is optimal for a given online platform may include parameters such as lighting (e.g., soft and natural or dramatic and artificial, etc.), artistic effects (e.g., black and white or sepia toned, soft focus, perspective, etc.), whether the subject is candid or posed (if a human subject), what the subject is wearing in the image (if a human subject), what the subject is doing in the image (if a human subject), the subject's facial expression (if a human subject, e.g., smiling and laughing or serious and thoughtful, etc.), whether the image is a facial image or a full body image (if a human subject), and other parameters.

For instance, the machine learning model may learn that for a professional networking social media platform, images of subjects dressed in professional attire receive better user engagement (e.g., more views, more messages or networking requests, etc.) than images of subjects dressed in casual attire. Thus, an image of a subject that is generated for the professional networking social media platform may depict the subject wearing a business suit (where, potentially, the plurality of images originally acquired in step 204 did not include an image of the subject wearing a business suit). In another example, the machine learning model may learn that for a social networking social media platform, candid images of subjects receive better user engagement (e.g., more likes) than images of subjects that appear more posed. Thus, an image of a subject that is generated for the social networking social media platform may depict the subject looking away from the camera or adopting a more relaxed posture (where, potentially, the plurality of images originally acquired in step 204 did not include an image of the subject looking away from the camera or adopting a more relaxed posture).

In one example, the processing system may have access to a plurality of different machine learning models, where each machine learning model of the plurality of machine learning models is trained to generate images for a different purpose or for a different type of online platform (or for a different, specific online platform). For instance, one machine learning model may be trained to generate professional images, another machine learning model may be trained to generate family friendly images, another machine learning model may be trained to generate images for dating purposes, and the like.

The new image may comprise a still image, a video, a virtual representation (e.g., an avatar or a three-dimensional model) of the subject, or another type of image, again depending on the type of online platform on which the new image is to be published. For instance, a profile image for a professional networking social media platform may comprise a still image, while a profile image for a gaming platform may comprise a virtual representation.

In optional step 212 (illustrated in phantom), the processing system may generate a recommendation, where the recommendation indicates that one of the first image or the new image should be used as the profile image for the subject. In one example, the new image that is generated in step 210 is one of a plurality of new images that is generated, and each new image of the plurality of new images may be scored to indicate how well the corresponding new image exhibits the characteristics associated with the set of criteria. The plurality of new images may then be ranked (e.g., in descending order) according to respective score, and the highest scoring new image may be included in the recommendation. In another example, the new image (or plurality of new images) may be ranked along with the plurality of images that was initially acquired in step 204, as it is possible that one of the originally acquired images may be assigned a higher score than a new image.

In one example, all of the new images of the plurality of new images (and, optionally, all of the images of the plurality of images acquired in step 204) may be presented to a user along with the corresponding scores for the images. The user may then manually select an image as the profile image for the subject, guided by the scores which may help to identify the potential “best” image(s) for the target online platform. For instance, the highest scoring new image for a human subject may depict the human subject in a business suit; however, the user may not like the color of the tie in the highest scoring new image and may select a different new image based on personal preferences.

The method 200 may end in step 214.

Thus, examples of the present disclosure select, or if needed, generate, a profile image for a subject, based on a plurality of sample images of the subject. For instance, given the plurality of sample images and a selection of a target online platform on which a profile image is to be displayed, examples of the present disclosure may automatically select the sample image that is likely to receive the best engagement (e.g., greatest number of views, likes, purchases, etc.) from other users of the target online platform. In further examples, examples of the present disclosure may generate a wholly new (e.g., synthetic, not previously existing) image of the subject that presents the subject in a manner that is consistent with high-exposure profile images on the target online platform. Thus, if no existing images of the subject are deemed suitable for the target online platform, examples of the present disclosure can create a suitable image. As such, the best possible first impression of the subject can be created.

As such, a user may be able to obtain a high quality profile image of a subject that is suitable for publication on a given online platform, even if the user does not have many images of the subject available, does not have an image of the subject that is suitable for the given online platform, or is unfamiliar with the online platform and the types of images published thereon. Examples of the present disclosure will learn what image characteristics are optimal (e.g., generate the greatest desirable engagement) for the given online platform, and will either select the user-provided image that best exhibits the image characteristics or will composite one or more of the user-provided images to generate a new image that exhibits the image characteristics.

Further examples of the present disclosure could potentially be extended to select or generate profile images based on the viewer of the profile (i.e., the specific individual viewing the profile). For instance, an online platform could utilize machine learning to learn the preferences of individual users with respect to profile images. These preferences could be stored in profiles for the individual users. Then, when an individual user views a profile of a subject, the available image of the subject that best matches the individual user's preferences could be selected for display as the profile image of the subject. In this way, different profile images could be presented to different viewers on the same online platform (e.g., based on individual preferences), rather than displaying the same profile image to all users on the online platform (e.g., based on some global set of preferences).

It should be noted that the method 200 may be expanded to include additional steps or may be modified to include additional operations with respect to the steps outlined above. In addition, although not specifically specified, one or more steps, functions, or operations of the method 200 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 2 that recite a determining operation or involve a decision do not necessarily require that both branches of the determining operation be practiced. In other words, one of the branches of the determining operation can be deemed as an optional step. Furthermore, steps, blocks, functions or operations of the above described method can be combined, separated, and/or performed in a different order from that described above, without departing from the examples of the present disclosure.

FIG. 3 depicts a high-level block diagram of a computing device or processing system specifically programmed to perform the functions described herein. As depicted in FIG. 3, the processing system 300 comprises one or more hardware processor elements 302 (e.g., a central processing unit (CPU), a microprocessor, or a multi-core processor), a memory 304 (e.g., random access memory (RAM) and/or read only memory (ROM)), a module 305 for automatically selecting or generating profile images for online use, and various input/output devices 306 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the method 200 as discussed above is implemented in a distributed or parallel manner for a particular illustrative example, i.e., the steps of the above method 200 or the entire method 200 is implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 302 can also be configured or programmed to cause other devices to perform one or more operations as discussed above. In other words, the hardware processor 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method 200. In one example, instructions and data for the present module or process 305 for automatically selecting or generating profile images for online use (e.g., a software program comprising computer-executable instructions) can be loaded into memory 304 and executed by hardware processor element 302 to implement the steps, functions, or operations as discussed above in connection with the illustrative method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 305 for automatically selecting or generating profile images for online use (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
acquiring, by a processing system including at least one processor, a plurality of images of a subject;
acquiring, by the processing system, a set of criteria for a profile image of the subject; and
generating, by the processing system, a new image of the subject, using the plurality of images of the subject and the set of criteria.

2. The method of claim 1, wherein the plurality of images of the subject includes at least one of: a still photograph of the subject, a video of the subject, or a virtual representation of the subject.

3. The method of claim 1, wherein the subject is a human subject, and the plurality of images includes at least one of: a facial image of the subject, a full body image of the subject, or a side image of the subject.

4. The method of claim 1, wherein the subject is a non-human subject, and the plurality of images includes at least one of: a front image of the subject, a back image of the subject, a side image of the subject, a top image of the subject, a bottom image of the subject, or an isometric image of the subject.

5. The method of claim 1, wherein the set of criteria indicates an online platform on which the profile image of the subject is to be published.

6. The method of claim 5, wherein the online platform comprises at least one of: a social networking social media platform, a professional networking social media platform, a microblogging platform, a media sharing platform, an e-commerce platform, or a dating platform.

7. The method of claim 1, wherein the set of criteria defines a desired perception of the profile image by viewers of the profile image.

8. The method of claim 7, wherein the desired perception is measured as a target number of views, a target number of likes, a target number of purchases, or a target number of hyperlink clicks.

9. The method of claim 1, wherein the set of criteria is predefined and associated with a specific type of online platform selected by a user.

10. The method of claim 9, wherein the set of criteria is learned using a machine learning model to identify image characteristics that lead to a desired perception by viewers of the specific type of online platform.

11. The method of claim 10, wherein the machine learning model is used to assign respective scores to the plurality of images, wherein a score of the respective scores indicates how well an associated image of the plurality of images exhibits the image characteristics, and wherein a first image is assigned a highest score of the respective scores.

12. The method of claim 1, wherein the generating is performed by providing the plurality of images of the subject to a machine learning model that is trained to output the new image for a specific online platform based on the plurality of images of the subject.

13. The method of claim 12, wherein the machine learning model comprises a modified generative adversarial network.

14. The method of claim 12, wherein the new image comprises a composite of at least one image of the plurality of images of the subject with learned image characteristics for the specific online platform.

15. The method of claim 14, wherein the learned image characteristics comprise image characteristics that are observed to lead to a desired perception by viewers of the specific online platform.

16. The method of claim 14, wherein the learned image characteristics comprise at least one of: image lighting, artistic effects, whether the subject is candid or posed, what the subject is depicted wearing, what the subject is depicted doing, a facial expression of the subject, or whether a facial image or a full body image is depicted.

17. The method of claim 1, further comprising:
selecting, by the processing system, a first image of the plurality of images as the profile image of the subject, wherein the first image is an image of the plurality of images that best meets the set of criteria.

18. The method of claim 1, further comprising:
generating, by the processing system, a recommendation, where the recommendation indicates that one of: a first image of the plurality of images or the new image should be used as the profile image for the subject.

19. A device comprising:
a processing system of an internet service provider network including at least one processor; and
a non-transitory computer-readable medium storing instructions which, when executed by the processing system, cause the processing system to perform operations, the operations comprising:
acquiring a plurality of images of a subject;
acquiring a set of criteria for a profile image of the subject; and
generating a new image of the subject, using the plurality of images of the subject and the set of criteria.

20. A non-transitory computer-readable medium storing instructions which, when executed by a processing system including at least one processor, cause the processing system to perform operations, the operations comprising:
acquiring a plurality of images of a subject;
acquiring a set of criteria for a profile image of the subject; and
generating a new image of the subject, using the plurality of images of the subject and the set of criteria.
